(19) United States
(12) Patent Application Publication
(10) Pub. No.: US 2019/0250065 A1
(43) Pub. Date: Aug. 15, 2019

(54) TESTING RIG PROVIDED WITH A MISALIGNMENT APPLYING UNIT FOR APPLYING A PARALLEL OFFSET TO A PORTION OF A TRANSMISSION ELEMENT

(71) Applicant: GE AVIO S.R.L., Rivalta di Torino (IT)

(72) Inventor: Paolo ALTAMURA, Monopoli (IT)

(21) Appl. No.: 16/310,062

(22) PCT Filed: Jun. 14, 2017
(86) PCT No.: PCT/EP2017/064521

§ 371 Date: Dec. 14, 2018

(30) Foreign Application Priority Data
Jun. 14, 2016 (IT) 102016000061208

(51) Int. Cl. G01M 13/027; G01M 15/14

(52) U.S. Cl. CPC G01M 13/027; G01M 15/14

(57) ABSTRACT

A testing rig has a fixed supporting structure, a motor device controlled to drive a shaft portion about a rotation axis, and a misalignment applying unit for applying a parallel offset to a portion of a transmission element that, in use, is under test. The misalignment applying unit is provided with a connecting member, designed to be fastened to the portion of the transmission element in a coaxial position along an axis, and with an eccentric bushing which is connected to the connecting member by an inner bearing in a rotational manner about such axis. The bushing is connected to the fixed supporting structure by an outer bearing in a rotational manner about a further axis which is parallel and eccentric. An actuator device is controlled to rotate the bushing with respect to the fixed supporting structure.

### BACKGROUND OF THE INVENTION

Embodiments of the present invention relate to a testing rig provided with a misalignment applying unit for applying a parallel offset to a portion of a transmission element which is under test. In particular, embodiments of the present invention relate to the testing of an epicyclic transmission for a turbine engine.

When the requirements of shafts and/or other transmission elements, in particular the fatigue life of a transmission, are tested, efforts are made to simulate specific load conditions and/or specific constraint conditions and/or specific deformation conditions, that can occur during the actual operation of the transmission.

A need is felt to provide testing conditions wherein a transmission element is supported at a first and a second end, and wherein the first end is arranged in a radially offset position with respect to a reference position, in which these two ends are coaxial along the axis of the transmission element.

In particular, a need is felt to provide a misalignment applying unit that can radially displace the first end of the transmission element from this reference position, while maintaining such first end in a parallel configuration, i.e. without any rotation.

### SUMMARY OF THE INVENTION

It is the object of embodiments of the present invention to propose a testing rig provided with a misalignment applying unit for applying a parallel offset to a portion of a transmission element, which allows to meet the above mentioned need in a simple and cost-effective manner and, in an embodiment, defines a compact and reliable solution.

According to embodiments of the present invention, a testing rig provided with a misalignment applying unit for applying a parallel offset to a portion of a transmission element is provided, as defined in claim 1.

### BRIEF DESCRIPTION OF THE DRAWINGS

Embodiments of the present invention will now be described with reference to the accompanying drawings, which show a non-limiting embodiment thereof, in which:

FIG. 1 is a diagram of an embodiment of the testing rig provided with a misalignment applying unit for applying a parallel offset to a portion of a transmission element, according to embodiments of the present invention;

FIG. 2 is a diagram showing, in a simplified manner, the deformation of the transmission element when the parallel offset is applied by the misalignment applying unit;

FIG. 3 is a perspective view of the misalignment applying unit in FIG. 1;

FIG. 4 is a cross section, along a vertical section plane, of the misalignment applying unit in FIG. 3;

FIG. 5 is a diagrammatic front view of the misalignment applying unit, in two operating conditions, to show the application of the parallel offset;

FIG. 6 shows a variant of the testing rig in FIG. 1; and

FIG. 7 is a diagrammatic front view showing a detail of the testing rig in FIGS. 1 and 6.

### DETAILED DESCRIPTION

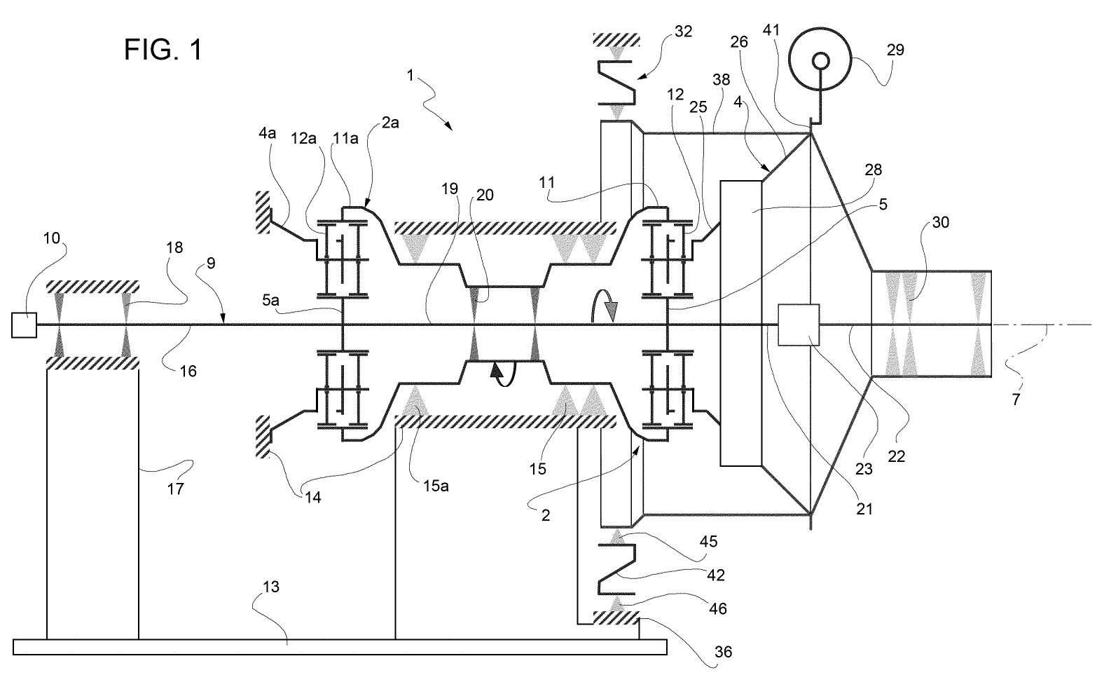

With reference to the diagram in FIG. 1, reference numeral 1 indicates a testing rig (diagrammatically shown), in particular for testing an epicyclic transmission 2 (diagrammatically shown) for a turbine engine.

The transmission 2 comprises a planet carrier 4 and a sun gear 5, which is rotational about an axis 7 and is angularly fixed with respect to a coaxial shaft 9, which in turn is driven about axis 7 by a motor device 10, defined in particular by an electric motor and controlled to maintain a given speed during a test.

The transmission 2 further comprises a ring gear 11, coaxial with sun gear 5, and a plurality of planet gears 12, which mesh with the sun gear 5 and the ring gear 11, are supported by the planet carrier 4 and are rotational about respective axes, which are parallel and eccentric with respect to axis 7.

In particular, according to the embodiment of FIG. 1, ring gear 11 is rotational, while planet carrier 4 is angularly stationary with respect to a bedplate 13 of the rig 1 during the test, so as to define a so-called “star configuration” for the transmission 2 that is under test.

When the transmission 2 is tested, the rig 1 employs a reaction transmission 2a, to simulate the actual operating conditions. Transmission 2a has parts that are identified, wherever possible, by the same reference numerals used for transmission 2, followed by the reference letter “a”. Transmissions 2 and 2a are arranged in positions which are symmetric with respect to a symmetry plane orthogonal to axis 7.

As diagrammatically shown in FIG. 1, ring gears 11 and 11a are coaxial and fixed one with respect to the other. In more detail, rig 1 comprises a fixed supporting frame 14, that is fastened to the bedplate 13 and supports the ring gears 11 and 11a by means of respective rolling bearings 15 and 15a.

Shaft 9 comprises an end portion 16, which is driven by motor device 10 (directly or by means of a transmission) and is coaxial and fixed with respect to sun gear 5a. Rig 1 comprises a pillar 17, which is fastened to the bedplate 13, can be distinct from frame 14, and supports the portion 16 by means of one or more rolling bearings 18.

Shaft 9 further comprises an intermediate portion 19, which is arranged between sun gears 5 and 5a, is coaxial and fixed with respect to sun gears 5 and 5a, and, in an embodiment is coupled to the ensemble of ring gears 11 and 11a by means of one or more bearings 20. In particular, bearings 20 are arranged in an axial position that is intermediate between bearings 15 and 15a.

At the axial end opposite to motor device 10, shaft 9 comprises two portions 21 and 22, connected to each other by means of a deformable connection element 23, which is rigid under torsional stresses about axis 7, to transfer torque actions, and is elastically deformable under radial stresses and also under bending stresses about axes orthogonal to axis 7.

Portion 21 is fixed and coaxial with respect to sun gear 5, while portion 22 defines a free end of shaft 9. Therefore, connection element 23 allows for a deflection or misalignment of portion 22 with respect to portion 21 and axis 7.

According to the embodiment shown in FIG. 1, planet carrier 4a is angularly stationary during the test, just as planet carrier 4. In particular, planet carrier 4a is directly fastened to frame 14.

On the other hand, planet carrier 4 comprises two opposite portions 25 and 26, connected to each other by means of a deformable connection element 28, which is rigid under torsional stresses about axis 7, to transfer torque actions, and is elastically deformable under radial stresses and also under bending stresses about axes orthogonal to axis 7.

Portion 25 defines an end supporting the planet gears 12. At the opposite end, portion 26 is angularly fixed with respect to bedplate 13 by a constraint device 29, which, in an embodiment, comprises at least one actuator controlled to apply a torque load (opposite to the one exerted by the motor device 10) on the portion 26.

Furthermore, portion 26 is coupled to portion 22 of shaft 9 by means of one or more rolling bearings 30.

Portions 26 and 22 radially move all together in relation to portions 25 and 21 under the action of a misalignment applying unit 32, that couples portion 26 to bedplate 13. In particular, unit 32 couples portion 26 to frame 14.

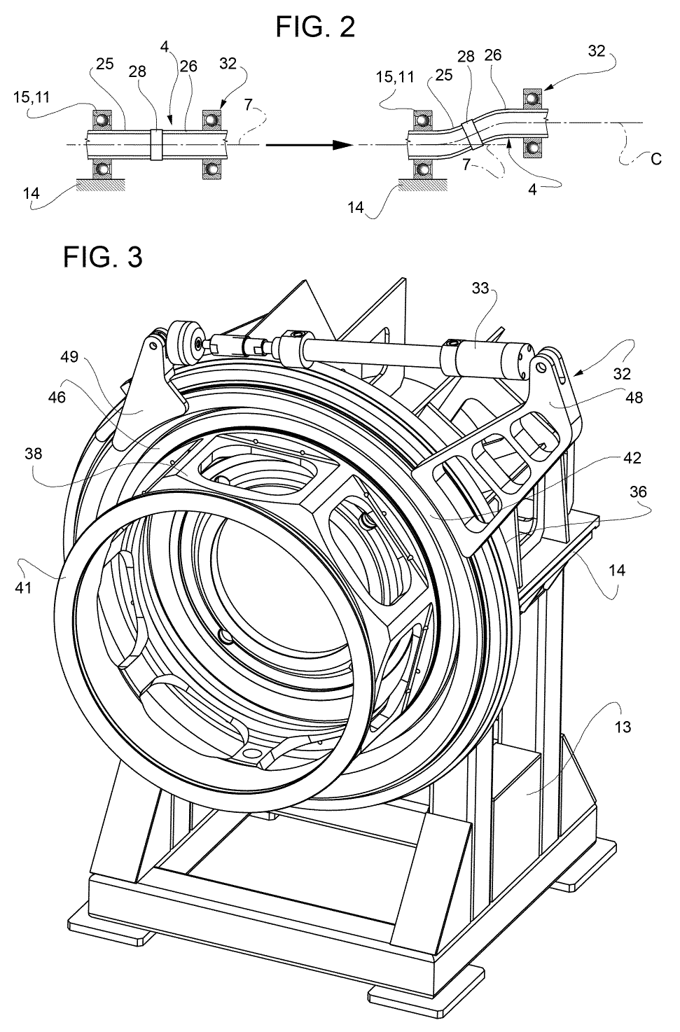

As diagrammatically shown in FIG. 2, unit 32 is controlled to radially translate portion 26 and, therefore, elastically deform the connection element 28, so as to set a desired parallel offset between portions 25 and 26. After having set a radial offset, portion 26 has an axis C that does not coincide with axis 7, as it is parallel and spaced apart in relation to axis 7 and to the previous position in the un-deformed condition.

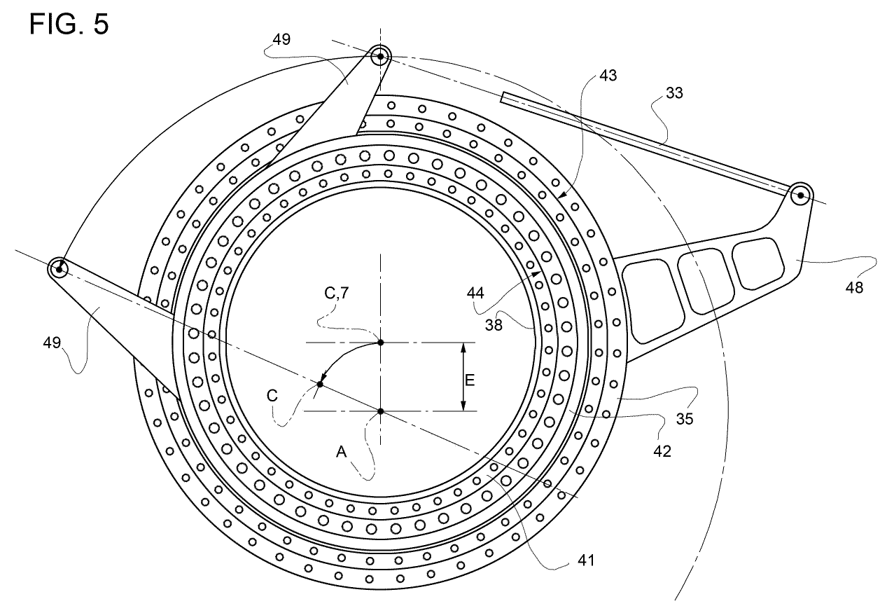

As shown in FIGS. 3 and 5, unit 32 comprises an actuator device 33 that is controlled to set a parallel radial offset between axes 7 and C and, in an embodiment, to adjust the extent of such offset. As shown in FIG. 1 and as already mentioned above, under the action of device 33, portion 22 translates together with portion 26, with the same offset, and therefore also connection 32 is elastically deformed.

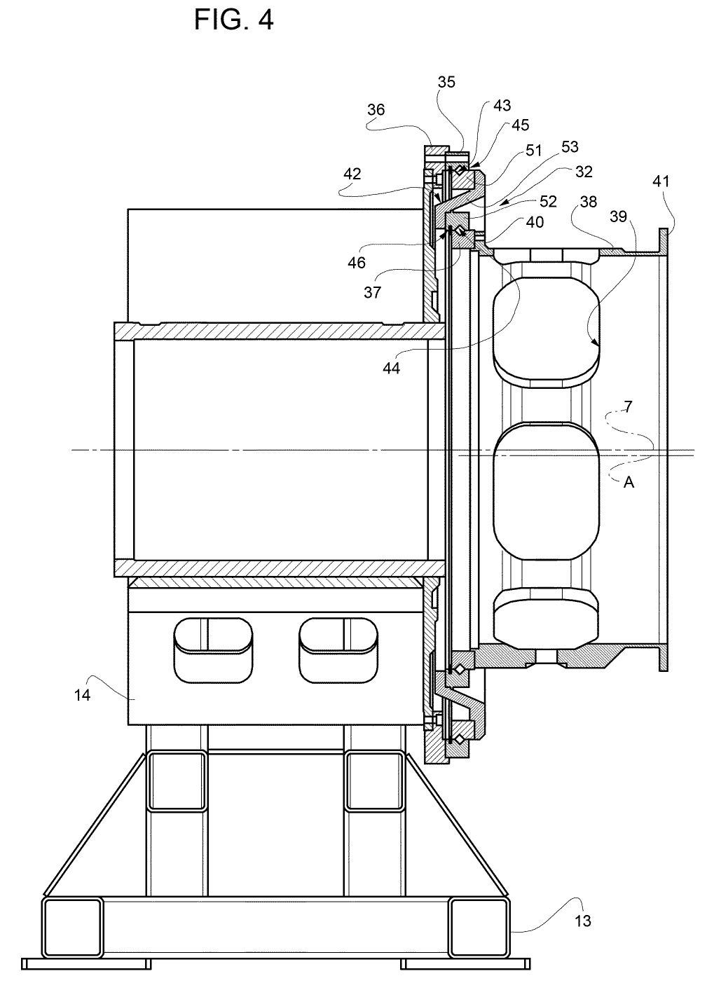

As shown in FIGS. 4 and 5, unit 32 comprises an outer circular ring 35, which is fastened and coaxial to a supporting ring 36 fixed to the frame 14. According to an aspect of embodiments of the present invention, supporting ring 36 has an axis A that is arranged in a fixed position and is parallel and eccentric with respect to axis 7. In particular, axis A is vertically aligned with, and arranged below, axis 7. However, it is possible to adjust the position of the supporting ring 36 with respect to the frame 14, according to a manner that is not described in detail, so as to adjust the position of axis A in the space around axis 7 and simulate different operating conditions. In particular, different fastening positions for the supporting ring 36 are defined by a set of holes: during assembly operations the supporting ring 36 is arranged in the desired position and, afterwards, is fastened to the frame 14 at the corresponding holes.

As shown in FIG. 4, unit 32 comprises an inner circular ring 37 and a connecting member 38 having an axial end 40 fastened to ring 37 and an opposite axial end 41 fastened to portion 26 (FIG. 1). Ring 37, member 38 and portion 26 are, therefore, fixed to each other and coaxial along axis C. In an embodiment, member 38 comprises a cylindrical sleeve, provided with openings 39 at an intermediate portion, and ends 40 and 41 are defined by respective outer flanges having holes for fastening screws or bolts.

According to an aspect of embodiments of the present invention, unit 32 further comprises an eccentric bushing 42 arranged in a position that is radially intermediate between rings 35 and 37. Bushing 42 has an outer circular surface 43 and an inner circular surface 44, which are eccentric one with respect to the other. As shown in FIG. 5, surface 43 is coaxial with ring 35 along axis A. Surface 44 is coaxial with ring 37 along axis C. The extent of the eccentricity E between the centers of surfaces 43 and 44 is the same between axis A and axis 7. By way of example, it is equal to about 10 mm.

With reference to FIG. 4, surfaces 43 and 44 are coupled respectively to rings 35 and 37 by means of rolling elements, so as to define respective rolling bearings 45 and 46. In other words, ring 35 and surface 43 respectively define the inner and outer races of the outer bearing 45, while ring 37 and surface 44 respectively define the inner and outer races of the inner bearing 46. The inner and outer races of the inner bearing 45 are concentric, and the inner and outer races of the inner bearing 46 are concentric.

The supporting ring 36 defines a centering arrangement for bearing 45, with the eccentricity E with respect to the centering arrangement provided for the bearings 15,15a in the frame 14.

Bearings 45 and 46 have to be chosen in the market so as to maintain a high position precision and to support high loads and moments. In particular, bearings 45 and 46 are defined by so-called “slewing bearings”.

With reference to FIG. 5, bushing 42 is driven by device 33 to rotate with respect to supporting ring 36 and frame 14 about axis A. During this rotation, axis C is angularly rotated about axis A from a first position, corresponding to the undeformed condition, in which axes 7 and C coincide, to a second position, corresponding to a deformed condition, in which axis C is radially offset and continues to be parallel with respect to axis 7. In FIG. 5, the angular distance between the first and second positions is not shown according to a real scale, but it is enlarged for a better understanding. By way of example it is possible to obtain an offset of about 2 mm.

In an embodiment, device 33 is defined by a linear actuator, arranged tangentially with respect to axes A and C. The opposite ends of such linear actuator are hinged to respective brackets 48 and 49, which outwardly project from, and are fixed to, supporting ring 36 and, respectively, bushing 42. However, a different actuator device (including a rotating motor with a worm screw acting on a worm gear, by way of example) could be provided to rotate bushing 42 in relation to supporting ring 36.

As shown in FIG. 4, in an embodiment, the cross-section of bushing 42 (made along a cross sectional plane on which axes 7 and A lie) has a Z-shape. Indeed, bushing 42 comprises an outer ring 51, defining surface 43; an inner ring 52, defining surface 44; and an intermediate element 53 having a substantially conical wall and opposite ends fastened to rings 51 and 52, e.g. by means of screws (not shown). In particular, such ends are defined by flanges fastened to rings 51 and 52 by means of screws or bolts. This kind of shape allows for an increased bending stiffness.

The intermediate element 53 has two centering arrangements, respectively for bearings 45 and 46: such centering arrangements are provided with the eccentricity E, one with respect to the other.

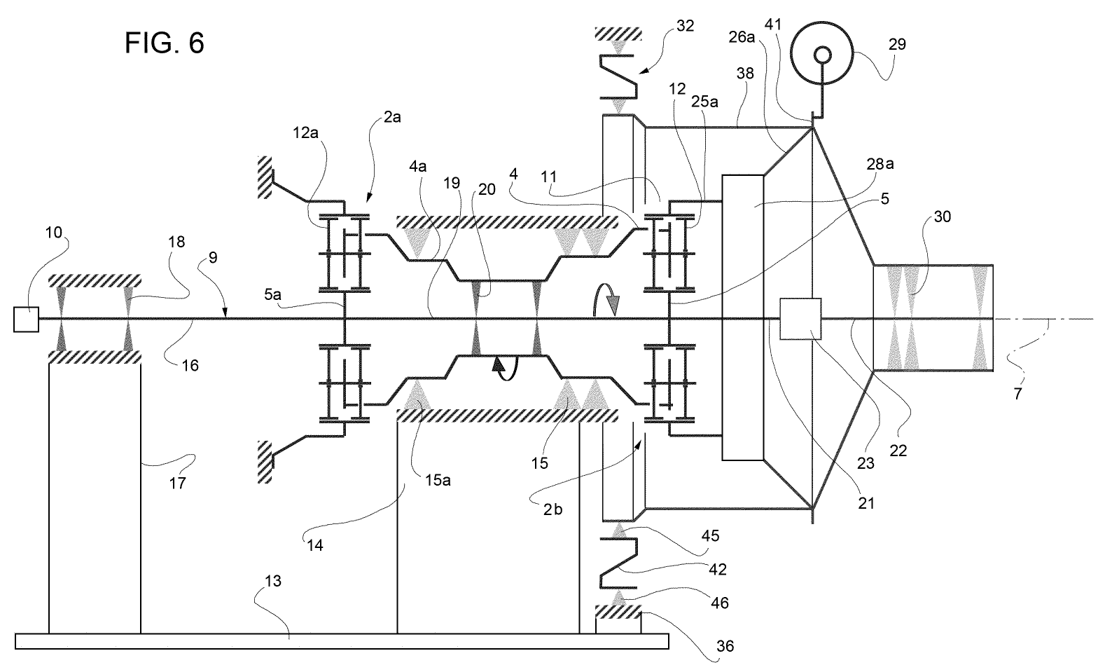

According to the variant shown in FIG. 6, the rig 1 is testing a transmission 2b that is configured in a “planetary” configuration and has parts that are identified, wherever possible, by the same reference numerals used for transmission 2. Transmission 2b differs from transmission 2 in planet carrier 4, which is rotational about axis 7 and is fixed and coaxial with respect to the planet carrier 4 of the reaction transmission 2a; in the meantime, ring gear 11a is directly fixed to frame 14 and ring gear 11 comprises portions 25a and 26a which are connected to each other by elastically deformable connecting element 28a. Just as for portion 26, portion 26a is angularly fixed to the bedplate 13 by means of device 29 and is subjected to the action of unit 32 so as to be radially offset with respect to portion 25a.

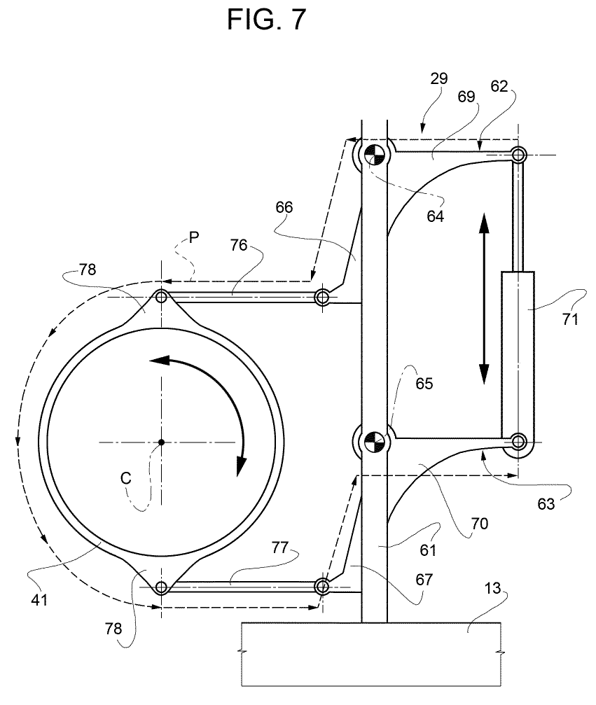

FIG. 7 shows a particular non-limiting embodiment for the device 29. Device 29 comprises a support element 61, e.g. a column, which is fixed to the bedplate 13, projects from the bedplate 13 and is arranged side by side and spaced apart from the end 41 of member 38. Device 29 further comprises two rocking levers 62 and 63 having respective intermediate portions hinged to the element 61 at hinge points 64,65 that are arranged different heights. Levers 62 and 63 end with respective arms 66,67, on one side, and with respective arms 69,70 on the other side. In an embodiment, levers 62 and 63 are identical in shape and size. Arms 66 and 69 form an acute angle with respect to the hinge point 64, and arms 67 and 70 form the same acute angle with respect to the hinge point 65.

Device 29 comprises a single actuator 71, which couples the outer ends of arms 69,70 to each other and, in particular, is defined by a linear hydraulic actuator.

Device 29 further comprises two rods 76,77 that are parallel to each other and are hinged at the levers 66,67, at one end, and to connecting portions 78 of the end 41, at the opposite end. Portions 78 are arranged at diametrically opposite positions with respect to the axis C and, in particular, are defined by outwardly projecting lugs.

The force of the actuator 71 exerts rotating torque actions on the levers 62,63. Such torque actions tend to rotate the levers 62 and 63 in opposite directions. The force of the actuator 71 is transferred by the levers 62,63 to the rods 76,77, so that one of the rods 76,77 is pushed, and the other is pulled, along their parallel axes.

The opposite actions on the rods 76,77 cause a torque load on member 38 and, therefore, on portion 26 (or 26a). Such torque load simulates the operating conditions of the transmission 2 and, therefore, the transmission 2a.

The force is transferred from the actuator 71 to the member 38 along a closed loop path P, so that there is only a reaction moment on the support element 61. Besides, the device 29 is insensitive to the position of the axis C, as the levers 62,63, the rods 76,77 and the actuator 71 automatically adapt their position in response to the radial offset movement of the axis C, thanks to the system of hinges coupling the above mentioned components. In particular, the rods 76,77 are always parallel, independently of the position of axis C.

During the assembly operations, after having adjusted the position of the supporting ring 36 so as to define the position of axis A, the bushing 42 is mounted in a configuration so as to align axis C of portions 22,26 with axis 7 of bearings 15,15a (zero radial offset). From this point, the angular rotation of bushing 42 causes the application and defines the extent of the parallel offset to the axis C of portions 22,26.

During the test, the motor device 10 keeps the rotation of shaft 9 at a given speed. At a steady state condition, the energy spent by the motor device 10 is equal to the losses of the transmissions 2 and 2a, e.g. losses due to friction. In the meantime, the device 29 holds the portion 26 in an angularly fixed position and exerts a torque load to simulate the operating load conditions. In the meantime, the parallel offset set by the unit 32 simulates specific constraint conditions that can occur during use. In particular, the unit 32 simulates the actual constraint motion (due to external loads) of different parts of the turbine frame where the transmission will be installed.

From the features described above, the advantages of the rig 1 claimed and described with reference to the accompanying drawings should be evident.

Indeed, unit 32 allows for applying a misalignment to portion 26 (or 26a) with a radial offset with respect to axis 7 and without rotations. Furthermore, thanks to the eccentric bushing 42, unit 32 is very compact.

Moreover, the extent of the parallel offset can be adjusted by applying a desired rotation angle on the bushing 42. It is also possible to adjust the position of axis A, and therefore the position of axis C, for a given extent of the parallel offset, by adjusting the position of ring 35 with respect to frame 14.

In the meantime, thanks to the rolling bearings 45 and 46, the positioning of axis C is relatively precise and stable and allows to obtaining the desired offset.

Member 38 axially spaces apart the actuator device 33 from the constraint device 29, and is not subject to torque stress.

It is apparent from the above features and considerations that modifications or variants may be made to unit 32 and rig 1 without departing from the scope of protection as defined by the appended claims.

In particular, unit 32 can be used in rigs configured to test transmission elements different from the components of an epicyclic transmission, and/or can be used to apply a parallel offset to a rotating transmission element.

The shape of the bushing 42 can be different from the one that has been shown as an embodiment.

Furthermore, rig 1 can have a fixed structure with parts different from bedplate 13, frame 14 and/or pillar 17.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A testing rig comprising a fixed supporting structure, a motor device controlled to drive a shaft portion about a rotation axis, and a misalignment applying unit for applying a parallel offset to a portion of a transmission element that, in use, is under test; wherein the misalignment applying unit comprises:
a connecting member having an axis and designed to be fastened to the portion in a coaxial position along the axis;
an eccentric bushing;
an inner bearing connecting the bushing to the connecting member in a rotational manner about the axis;
an outer bearing connecting the eccentric bushing to the fixed supporting structure in a rotational manner about a further axis, which is parallel and eccentric with respect to the axis and the rotation axis;
an actuator device controlled to rotate the eccentric bushing with respect to the fixed supporting structure.

2. The testing rig according to claim 1, wherein the inner and outer bearings are both defined by rolling bearings.

3. The testing rig according to claim 1, wherein the actuator device is defined by a linear actuator.

4. The testing rig according to claim 1, wherein the cross section of the eccentric bushing, along a cross sectional plane on which the rotation axis and the further axis lie, has a Z-shape.

5. The testing rig according to claim 4, wherein the eccentric bushing comprises:
a first ring defining an inner race of the outer bearing;
a second ring defining an outer race of the inner bearing;
an intermediate element having a substantially conical wall and opposite ends fastened to the first and second rings.

6. The testing rig according to claim 1, wherein the connecting member has:
a first end fastened to a third ring defining an inner race of the inner bearing;
a second end which is axially opposite to the first end and is designed to be fastened to the portion.

7. The testing rig according to claim 6, wherein the first and second ends are defined by respective outer flanges having holes.

8. The testing rig according to claim 1, wherein the outer bearing has an outer race which is fixed and coaxial to a supporting ring; the position of the supporting ring being adjustable with respect to the fixed supporting structure so as to adjust the position of the further axis.

9. The testing rig according to claim 1, wherein comprising a constraint device that angularly fixes the connecting member about the rotation axis with respect to the fixed supporting structure and comprises at least one actuator controlled to apply a torque load to the portion.

10. The testing rig according to claim 9, wherein the constraint device comprises a single actuator.
